(19) United States
(12) Patent Application Publication
(10) Pub. No.: US 2026/0312952 A1
(43) Pub. Date: Oct. 8, 2026

(54) INTEGRATION ENABLER FOR INTEGRATING METAVERSE SYSTEM WITH DIGITAL TWIN SYSTEM AND/OR THIRD-PARTY SERVICE SYSTEM AND METHOD OF OPERATING THE SAME

(71) Applicant: Electronics and Telecommunications Research Institute, Daejeon (KR)

(72) Inventors: Changkyu LEE, Daejeon (KR); Seung Yun LEE, Daejeon (KR)

(73) Assignee: Electronics and Telecommunications Research Institute, Daejeon (KR)

(21) Appl. No.: 19/575,119

(22) Filed: Mar. 23, 2026

(30) Foreign Application Priority Data
Apr. 7, 2025 (KR) 10-2025-0044594
Feb. 3, 2026 (KR) 10-2026-0021806

(51) Int. Cl. H04L 9/40; G06F 30/20

(52) U.S. Cl. CPC H04L 63/0884; G06F 30/20

(57) ABSTRACT

An integration enabler for integrating a metaverse system with a digital twin system and/or a third-party service system and a method of operating the same are provided. The method of operating the integration enabler includes receiving, from a metaverse system, authentication information to receive a third-party service selected by a user of the metaverse system among third-party services provided by a third-party service system, transmitting the authentication information to the third-party service system, receiving an authentication result based on the authentication information from the third-party service system, and when authentication for the user is successful based on the authentication result, exchanging service data for the third-party service with the metaverse system so that the metaverse system receives the third-party service.

### CROSS-REFERENCE TO RELATED APPLICATIONS

This application claims the benefit of Korean Patent Application No. 10-2025-0044594, filed on Apr. 7, 2025, and Korean Patent Application No. 10-2026-0021806, filed on Feb. 3, 2026, in the Korean Intellectual Property Office (now the Ministry of Intellectual Property (MOIP)), the entire disclosures of which are incorporated herein by reference for all purposes.

### BACKGROUND

### 1. Field of the Invention

One or more embodiments relate to an integration enabler for integrating a metaverse system with a digital twin system and/or a third-party service system and a method of operating the same.

### 2. Description of the Related Art

A digital twin is a technology that creates a twin of a real-world object on a computer and simulates situations that may occur in the real world by the computer to predict a result in advance. The digital twin is attracting attention as a technology that may solve various industrial and social problems, not just manufacturing problems.

The digital twin is essentially a combination of data representing structures, contexts, and operations of various physical systems, and may be considered an operating entity that may understand past and present operating states and predict the future. The digital twin is a powerful digital entity that may be used to optimize the physical world, and may improve operational performance and business processes.

The above description is information the inventor(s) acquired during the course of conceiving the present disclosure, or already possessed at the time, and is not necessarily art publicly known before the present application was filed.

### SUMMARY

Embodiments provide integrating a physical world and a virtual world using a digital twin.

Embodiments provide integrating a metaverse system and a digital twin system using a digital twin and integrating the metaverse system and a third-party service system.

Embodiments provide authenticating access rights of users of a metaverse system, desired to receive a third-party service, by interacting with a third-party service system.

Embodiments provide authenticating access rights of users of a metaverse system, desired to receive a digital twin model managed by a digital twin system, by interacting with the digital twin system.

However, the technical aspects are not limited to the aspects described above, and there may be other technical aspects.

According to an aspect, there is provided a method of operating an integration enabler, the method including receiving, from a metaverse system, authentication information to receive a third-party service selected by a user of the metaverse system among third-party services provided by a third-party service system, transmitting the authentication information to the third-party service system, receiving an authentication result based on the authentication information from the third-party service system, and when authentication for the user is successful based on the authentication result, exchanging service data for the third-party service with the metaverse system so that the metaverse system receives the third-party service.

The transmitting of the authentication information to the third-party service system may include verifying access rights to the third-party service by interacting with the metaverse system.

The transmitting of the authentication information to the third-party service system may include transmitting authentication credentials or tokens for verifying access rights of the user to the third-party service system, and receiving an authentication result based on the authentication credentials or the tokens from the third-party service system.

The authentication credentials and the tokens may be changed into a format required by the third-party service system.

The receiving of the authentication result from the third-party service system may include receiving authorization metadata including at least one of token expiration, scope, or user roles to inform access control determinations of the third-party service system.

The transmitting of the authentication information to the third-party service system may include verifying authentication requirements for the third-party services, and changing a format of a message including the authentication information based on the authentication requirements and transmitting the changed message to the third-party service system.

The exchanging of the service data with the metaverse system may include exchanging the service data with the metaverse system by converting a communication protocol between the metaverse system and the third-party service system.

The authentication result may include at least one of access tokens and assertions for the third-party service.

According to another aspect, there is provided a method of operating an integration enabler, the method including receiving, from a metaverse system, authentication information for accessing a digital twin model selected by a user of the metaverse system among digital twin models managed by a digital twin system, transmitting the authentication information to the digital twin system, receiving an authentication result based on the authentication information from the digital twin system, when authentication for the user is successful based on the authentication result, transmitting a transmission request of the digital twin model to the digital twin system, and transmitting the digital twin model received in response to the transmission request to the metaverse system.

The transmitting of the authentication information to the digital twin system may include verifying access rights to the digital twin system by interacting with the digital twin system.

The transmitting of the authentication information to the digital twin system may include transmitting authentication credentials or tokens for verifying an identity of the user to the digital twin system, and receiving, from the digital twin system, an authentication result including an identity mapped to the user and authentication success or failure, based on the authentication credentials or the tokens.

The transmitting of the digital twin model to the metaverse system may include determining whether a format of the digital twin system and the metaverse system is different from each other, and changing the format of the selected digital twin model and transmitting the changed digital twin model to the metaverse system, in response to determining that the format is different from each other.

According to another aspect, there is provided an integration enabler including a processor, and memory storing instructions. The instructions, when executed by the processor, cause the integration enabler to receive, from a metaverse system, authentication information to receive a third-party service selected by a user of the metaverse system among third-party services provided by a third-party service system, transmit the authentication information to the third-party service system, receive an authentication result based on the authentication information from the third-party service system, and when authentication for the user is successful based on the authentication result, exchange service data for the third-party service with the metaverse system so that the metaverse system receives the third-party service.

The instructions, when executed by the processor, may cause the integration enabler to verify access rights to the third-party service by interacting with the metaverse system.

The instructions, when executed by the processor, may cause the integration enabler to transmit authentication credentials or tokens for verifying access rights of the user to the third-party service system, and receive, from the third-party service system, an authentication result including access tokens and assertions for the third-party service according to the authentication credentials or the tokens.

The authentication credentials and the tokens may be changed into a format required by the third-party service system.

The instructions, when executed by the processor, may cause the integration enabler to receive authorization metadata including at least one of token expiration, scope, or user roles to inform access control determinations of the third-party service system.

The instructions, when executed by the processor, may cause the integration enabler to verify authentication requirements for the third-party service, and change a format of a message including the authentication information based on the authentication requirements and transmit the changed message to the third-party service system.

The instructions, when executed by the processor, may cause the integration enabler to exchange the service data with the metaverse system by converting a communication protocol between the metaverse system and the third-party service system.

Additional aspects of embodiments will be set forth in part in the description which follows and, in part, will be apparent from the description, or may be learned by practice of the disclosure.

According to embodiments, integrating a physical world and a virtual world through a digital twin may provide a user with a more realistic metaverse.

According to embodiments, integrating a physical world and a virtual world may provide a user with various functions and services in a metaverse and expands user experience.

According to embodiments, performing user authentication of a metaverse system may ensure authorized user access to various third-party services or various digital twin systems.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 is a diagram illustrating an integration enabler according to an embodiment;

FIG. 2 is a diagram illustrating functions of a metaverse system according to an embodiment;

FIG. 3 is a diagram illustrating functions of a digital twin system according to an embodiment;

FIG. 4 is a diagram illustrating functions of a third-party service system according to an embodiment;

FIG. 5 is a diagram illustrating functions of an integration enabler according to an embodiment;

FIG. 6 is a diagram illustrating interfaces and reference points between an integration enabler, a metaverse system, a third-party service system, and a digital twin system according to an embodiment;

FIG. 7 is a diagram illustrating an operation flow of an integration enabler for integrating a third-party service system and a metaverse system according to an embodiment;

FIG. 8 is a diagram illustrating an operation flow of authenticating a user of a metaverse system to receive a third-party service according to an embodiment;

FIG. 9 is a diagram illustrating an operation flow of an integration enabler for integrating a digital twin system and a metaverse system according to an embodiment;

FIG. 10 is a diagram illustrating an operation flow of authenticating a user of a metaverse system to receive a digital twin model according to an embodiment;

FIG. 11 is a flowchart illustrating a method of operating an integration enabler for authenticating a user by interacting with a third-party service system according to an embodiment;

FIG. 12 is a flowchart illustrating a method of operating an integration enabler for authenticating a user by interacting with a digital twin system according to an embodiment; and

FIG. 13 is a block diagram illustrating an integration enabler according to an embodiment.

### DETAILED DESCRIPTION

The following detailed structural or functional description is provided as an example only and various alterations and modifications may be made to the embodiments. Accordingly, the embodiments are not to be construed as limited to the disclosure and should be understood to include all changes, equivalents, or replacements within the idea and the technical scope of the disclosure.

Although terms of “first,” “second,” and the like are used to explain various components, the components are not limited to such terms. These terms are used only to distinguish one component from another component. For example, a first component may be referred to as a second component, or similarly, the second component may be referred to as the first component.

It should be noted that if it is described that one component is “connected,” “coupled,” or “joined” to another component, a third component may be “connected,” “coupled,” and “joined” between the first and second components, although the first component may be directly connected, coupled, or joined to the second component.

As used herein, the singular forms “a,” “an,” and “the” are intended to include the plural forms as well, unless the context clearly indicates otherwise. As used herein, “A or B,” “at least one of A and B,” “at least one of A or B,” “A, B or C,” “at least one of A, B and C,” and “at least one of A, B, or C,” each of which may include any one of the items listed together in the corresponding one of the phrases, or all possible combinations thereof. It will be further understood that the terms “comprises” and/or “comprising,” when used in this specification, specify the presence of stated features, integers, steps, operations, elements, components or a combination thereof, but do not preclude the presence or addition of one or more other features, integers, steps, operations, elements, components, and/or groups thereof.

Unless otherwise defined, all terms, including technical and scientific terms, used herein have the same meaning as commonly understood by one of ordinary skill in the art to which this disclosure pertains. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

As used in connection with various embodiments of the disclosure, the term “module” may include a unit implemented in hardware, software, or firmware, and may interchangeably be used with other terms, for example, “logic,” “logic block,” “part,” or “circuitry.” A module may be a single integral component, or a minimum unit or part thereof, adapted to perform one or more functions. For example, according to an embodiment, the module may be implemented in a form of an application-specific integrated circuit (ASIC).

The term “unit” or the like used herein may refer to a software or hardware component, such as a field-programmable gate array (FPGA) or an ASIC, and the “unit” performs predefined functions. However, the term “unit” is not limited to software or hardware. A “unit” may be configured to be in an addressable storage medium or configured to operate one or more processors. Accordingly, the “unit” may include, for example, components, such as software components, object-oriented software components, class components, and task components, processes, functions, attributes, procedures, sub-routines, segments of program code, drivers, firmware, microcode, circuitry, data, databases, data structures, tables, arrays, and variables. The functionalities provided in the components and “units” may be combined into fewer components and “units” or may be further separated into additional components and “units.” Furthermore, the components and “units” may be implemented to operate on one or more central processing units (CPUs) within a device or a security multimedia card. In addition, “unit” may include one or more processors.

Hereinafter, embodiments will be described in detail with reference to the accompanying drawings. When describing the embodiments with reference to the accompanying drawings, like reference numerals refer to like components and a repeated description related thereto will be omitted.

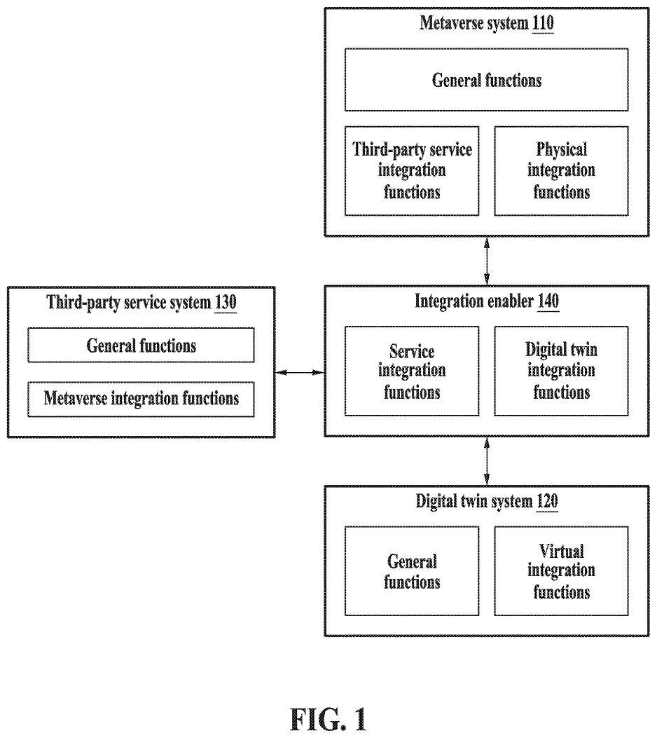

FIG. 1 is a diagram illustrating an integration enabler according to an embodiment.

Referring to FIG. 1, an integration enabler 140 may integrate a metaverse system 110 and a digital twin system 120 through a digital twin, thereby integrating a virtual world and a physical world. In addition, the integration enabler 140 may selectively integrate the metaverse system 110 with a third-party service system 130 while integrating the metaverse system 110 and the digital twin system 120.

A physical object may refer to an object that exists in the physical world. For example, the physical object may refer to an object having a distinct existence in the physical world, whether tangible (e.g., a machine or a device) or intangible (e.g., a process or a traffic flow). In the disclosure, for convenience of description, the physical object may also be referred to as an actual object or a real-world object.

A virtual object may refer to a computer-generated entity designated for the virtual world. The virtual object may be a replica associated with a physical object and may serve as a digital twin.

The physical world may refer to a spatial organization of a plurality of physical objects. In the disclosure, for convenience of description, the physical world may also be referred to as the actual world or the real world.

The virtual world may refer to a spatial organization of a plurality of virtual objects. The virtual world may include global behavior. In the virtual world, users may generate avatars representing themselves and may interact with virtual objects and other avatars in various ways.

A metaverse may refer to a collective virtual environment in which the physical world and the virtual world are converged to allow a user to interact with shared digital spaces, objects, and services. The metaverse may be virtual, may be augmented, may represent the real world, or may be associated with the real world. In other words, the metaverse may include virtual reality (VR), augmented reality (AR), and mixed reality (MR). The metaverse may be an integrated ecosystem of virtual worlds that provides a user with an immersive experience and may modify existing elements from economic, environmental, social, or cultural perspectives and generate new values. The metaverse may include virtual worlds implemented to enable human activities of the real world.

A digital twin may refer to a digital representation of an object of interest. For example, the digital twin may refer to a digital representation that implements physical objects of the physical world in a virtual world or a metaverse. The digital twin may require different functions (e.g., synchronization or real-time support) depending on application fields. The digital twin may serve to associate the virtual world with the physical world and may enable a user to extend experience beyond the limitations of a virtual environment. As a digital representation of physical objects, the digital twin may be part of the virtual world. For example, an avatar that represents a user may be a digital twin in the virtual world. The digital twin may function as an entity that operates between the two worlds to associate the virtual world with the physical world. For example, a digital twin of a user may be implemented as an avatar and may reflect facial expressions captured by user equipment.

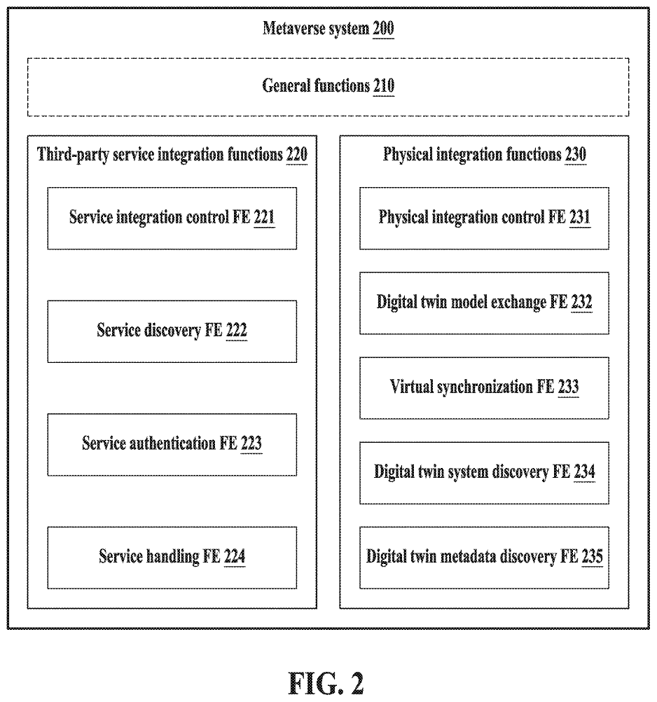

The metaverse system 110 may implement a metaverse service by designing and providing a virtual world customized based on user preferences. The metaverse system 110 may provide general functions (GFs), third-party service integration functions (TSIFs), and physical integration functions (PIFs). The PIFs provided by the metaverse system 110 are described in detail below with reference to FIG. 2.

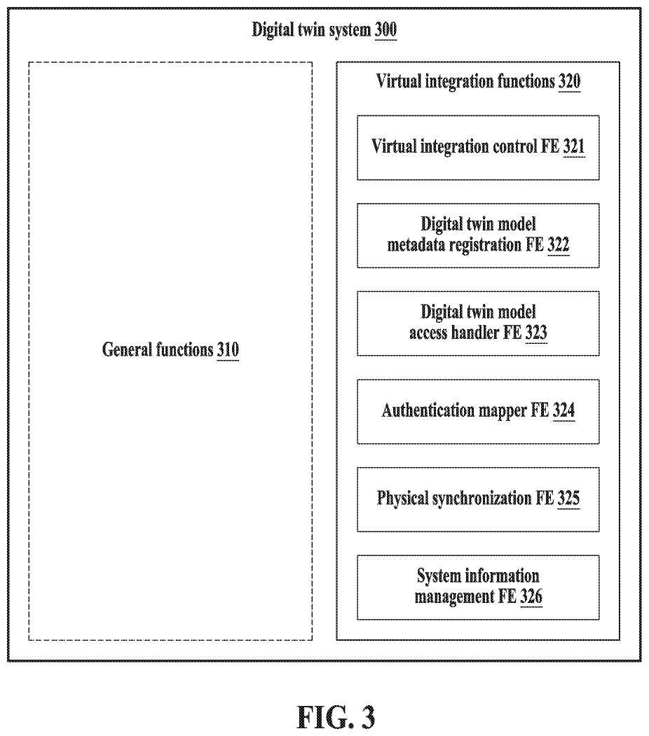

The digital twin system 120 may manage a digital representation of a physical object referred to as a digital twin and may perform synchronization between the physical object and the digital twin. The digital twin system 120 may provide GFs and virtual integration functions (VIFs). The VIFs provided by the digital twin system 120 are described in detail below with reference to FIG. 3.

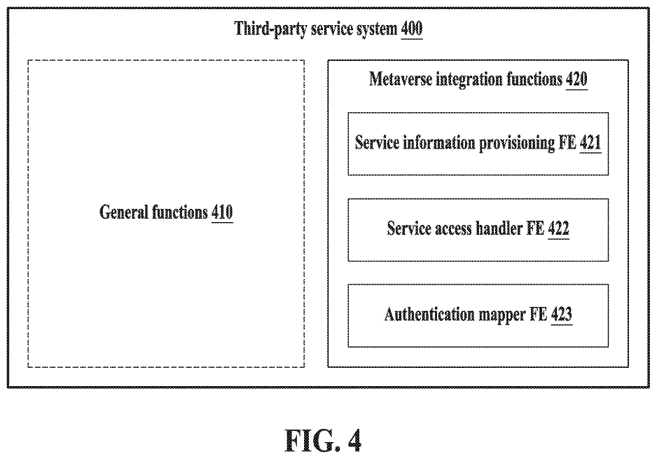

The third-party service system 130 may provide external services such as payment processing, logistics, or online shopping and may integrate these services into a metaverse to enhance functions and provide a user with a richer and more interactive experience. In the disclosure, for convenience of description, an external service provided by the third-party service system 130 may also be referred to as a third-party service. The third-party service system 130 may provide GFs and metaverse integration functions (MIFs). The MIFs provided by the third-party service system 130 are described in detail below with reference to FIG. 4.

In an embodiment, the metaverse system 110, the digital twin system 120, and the third-party service system 130 may each be implemented as an electronic device including a processor and a memory.

The integration enabler 140, as illustrated in FIG. 1, may be a standalone system, but may alternatively be included in the metaverse system 110 or the digital twin system 120 according to embodiments. For example, the integration enabler 140 may be implemented as a set of functions existing in the metaverse system 110 and/or the digital twin system 120. For instance, the integration enabler 140 may be implemented by a processor included in the metaverse system 110 or the digital twin system 120.

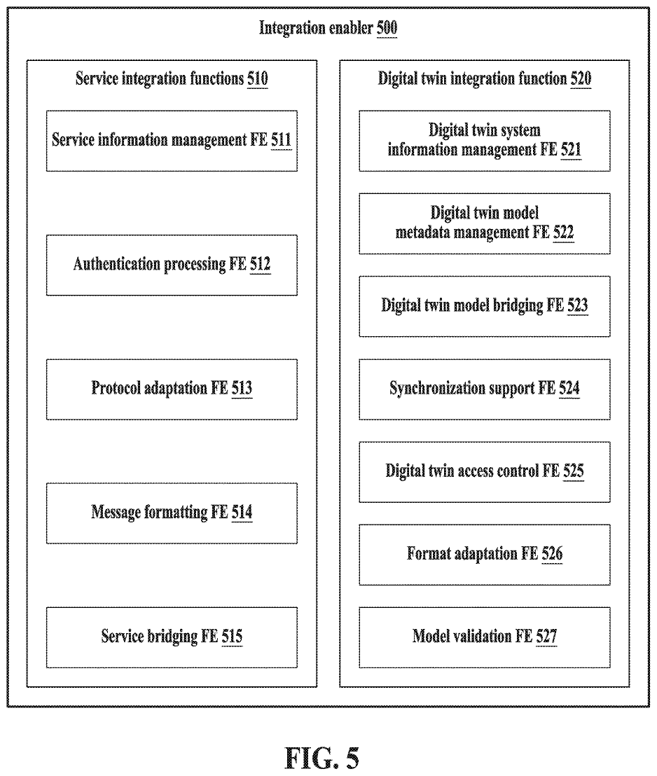

According to an embodiment, the integration enabler 140 may serve as a core management framework that enables seamless integration between the metaverse system 110 and the digital twin system 120. The integration enabler 140 may provide a function for interacting with the digital twin system 120 such that a physical object may be used as a virtual object in a metaverse. The integration enabler 140 may include various service integration functions (SIFs) and digital twin integration functions (DTIFs). The DTIFs provided by the integration enabler 140 are described in detail below with reference to FIG. 5.

FIG. 2 is a diagram illustrating functions of a metaverse system according to an embodiment.

Referring to FIG. 2, a metaverse system 200 may provide GFs 210, TSIFs 220, and PIFs 230. The TSIFs 220 and the PIFs 230 illustrated in FIG. 2 are only examples for description, and embodiments are not limited thereto. For example, the metaverse system 200 may be implemented by excluding some of the TSIFs 220 or the PIFs 230 illustrated in FIG. 2 or by adding other functions.

The GFs 210 may be functions required for the metaverse system 200 to provide a standalone service. The GFs 210 may include one or more functions for integrating a digital twin, which is a virtual object, with a corresponding physical object. The TSIFs 220 may support integration with a third-party service system. The PIFs 230 may support integration with a digital twin system.

In the disclosure, a functional entity (FE) may refer to a functional element for achieving a particular operational purpose. For example, an FE may refer to a function that is not further subdivided. The GFs 210 illustrated in FIG. 2 and the operations represented by the FEs illustrated therein may be performed by at least one component (e.g., a processor) of the metaverse system 200.

A service integration control FE (SIC-FE) 221 may provide a function for determining whether interaction with external third-party service systems is required in response to a user request in the metaverse system 200. The SIC-FE 221 may coordinate a service flow that includes service discovery, authentication, and session invocation. In addition, the SIC-FE 221 may interact with the GFs 210 of the metaverse system 200 to initiate or manage services related to external integration.

A service discovery FE (SD-FE) 222 may provide a function for discovering metadata of available third-party services by interacting with an integration enabler under the control of the SIC-FE 221. The SD-FE 222 may enable the metaverse system 200 to identify services that satisfy user request criteria. The identified services may be transmitted to the SIC-FE 221 to support decision making on service invocation.

A service authentication FE (SA-FE) 223 may provide a function for initiating and managing an authentication process with external third-party services. The SA-FE 223 may interact with authentication handling mechanisms of the integration enabler to verify user authentication credentials and may ensure authorized access to requested services. The authentication process may be initiated under the control of the SIC-FE 221.

A service handling FE (SH-FE) 224 may provide a function for managing an actual interaction session between the metaverse system 200 and a third-party service system. The SH-FE 224 may handle service invocation, data exchange, and session lifecycle management through the integration enabler. The SH-FE 224 may operate under the guidance of the SIC-FE 221 to ensure that user experience is maintained consistently and safely during external service execution.

A physical integration control FE (PIC-FE) 231 may provide a function for connecting a virtual world managed by the metaverse system 200 to a physical world by integrating with a digital twin system. The PIC-FE 231 may oversee the entire process of importing or exporting a digital twin model, manage a synchronization flow, and interact with the GFs 210 of the metaverse system 200 to perform core coordination responsibilities.

A digital twin model exchange FE (DTME-FE) 232 may provide a function for importing digital twin models from a digital twin system into a metaverse environment and exporting virtual models generated in the metaverse back to digital twin systems. The DTME-FE 232 may serve as an interface for model exchange and may be coordinated by the PIC-FE 231.

A virtual synchronization FE (VS-FE) 233 may provide a function for initiating and managing synchronization between virtual objects of the metaverse and corresponding physical objects. When a user modifies a digital twin in a virtual world, the VS-FE 233 may interoperate with the integration enabler to reflect changes in the physical world under the control of the digital twin system. In addition, the VS-FE 233 may support reflecting changes in the physical world back to the virtual environment. The VS-FE 233 may be controlled by the PIC-FE 231.

A digital twin system discovery FE (DTSD-FE) 234 may provide a function for discovering and displaying a list of available digital twin systems registered with the integration enabler. The metaverse system 200 may identify and select an appropriate digital twin system before discovering digital twin model metadata. The DTSD-FE 234 may operate under the control of the PIC-FE 231.

A digital twin metadata discovery FE (DTMD-FE) 235 may provide a function for discovering metadata of available digital twin models managed by digital twin systems. Metadata obtained through the integration enabler may be used to provide a catalog for selecting and configuring digital twins in a virtual world. The DTMD-FE 235 may operate under the control of the PIC-FE 231.

FIG. 3 is a diagram illustrating functions of a digital twin system according to an embodiment.

Referring to FIG. 3, a digital twin system 300 may provide GFs 310 and VIFs 320. The VIFs 320 illustrated in FIG. 3 are only examples for description, and embodiments are not limited thereto. For example, the digital twin system 300 may be implemented by excluding some of the VIFs 320 illustrated in FIG. 3 or by adding other functions.

The GFs 310 may be functions required for the digital twin system 300 to provide a standalone service. The GFs 310 may include one or more functions for integrating a physical object with a corresponding digital twin. The VIFs 320 may support integration with a metaverse system.

The GFs 310 illustrated in FIG. 3 and the operations represented by the FEs illustrated therein may be performed by at least one component (e.g., a processor) of the digital twin system 300.

A virtual integration control FE (VIC-FE) 321 may provide a function for controlling an overall interaction flow between the digital twin system 300 and the metaverse system through an integration enabler. For example, the VIC-FE 321 may coordinate tasks such as digital twin model exchange, metadata management, and synchronization support. In addition, the VIC-FE 321 may interact with the GFs 310 of the digital twin system 300 to support core decision making and control.

A digital twin model metadata registration FE (DTMMR-FE) 322 may provide a function for registering metadata of digital twin models managed by the digital twin system 300. The DTMMR-FE 322 may operate under the control of the VIC-FE 321, and the VIC-FE 321 may determine metadata to be shared with the integration enabler for cataloging and discovery in the metaverse system.

A digital twin model access handler FE (DTMAH-FE) 323 may provide a function for processing import and export requests for digital twin models. The DTMAH-FE 323 may process requests received by the integration enabler after authentication and may delegate model upload or discovery tasks to the VIC-FE 321, which interacts with the GFs 310.

An authentication mapper FE (AM-FE) 324 may provide a function for mapping authentication credentials of the integration enabler to internal authentication schemes of the digital twin system 300. The AM-FE 324 may be invoked by a digital twin access control FE (DTAC-FE) of the integration enabler and may verify access, in collaboration with internal authentication mechanisms, before permitting model or metadata operations.

A physical synchronization FE (PS-FE) 325 may provide a function for performing synchronization between physical objects associated with virtual objects (e.g., digital twin models). When a synchronization request is received through the integration enabler, the PS-FE 325 may forward the received synchronization request to internal control logic and may ensure that changes in the virtual domain or the physical domain are appropriately propagated.

A system information management FE (SIM-FE) 326 may provide a function for registering system-level metadata (e.g., provider name or network address) of the digital twin system 300. The SIM-FE 326 may discover information from the GFs 310 and may transmit the information to the integration enabler for registration such that the metaverse system may identify and access the information.

FIG. 4 is a diagram illustrating functions of a third-party service system according to an embodiment.

Referring to FIG. 4, a third-party service system 400 may provide GFs 410 and MIFs 420. The MIFs 420 illustrated in FIG. 4 are only examples for description, and embodiments are not limited thereto. For example, the third-party service system 400 may be implemented by excluding some of the MIFs 420 illustrated in FIG. 4 or by adding other functions.

The GFs 410 may be functions required for the third-party service system 400 to provide a standalone service. The GFs 410 may include one or more functions for integrating a third-party service with a metaverse. The MIFs 420 may support integration with a metaverse system.

A service information provisioning FE (SIP-FE) 421 may provide a function for providing and managing metadata of services offered by the third-party service system 400. The SIP-FE 421 may obtain service information from the GFs 410 and may register or update the metadata with a SIM-FE of an integration enabler. The SIP-FE 421 may enable the metaverse system to discover the services.

A service access handler FE (SAH-FE) 422 may provide a function for receiving service-related requests and authentication-related requests from the integration enabler. The SAH-FE 422 may serve as a single-entry point for external integrations and may forward the requests to appropriate internal components of the third-party service system 400. In addition, the SAH-FE 422 may mediate communication with internal systems, such as support mappers or the GFs 410, depending on the type and purpose of the request.

An authentication mapper FE (AM-FE) 423 may provide a function for adapting and converting authentication credentials or tokens received from the integration enabler into formats compatible with internal authentication logic of the third-party service system 400. The AM-FE 423 may operate with the SAH-FE 422 to support safe and consistent authentication flows without modifying internal authentication mechanisms of the third-party service system 400.

FIG. 5 is a diagram illustrating functions of an integration enabler according to an embodiment.

Referring to FIG. 5, an integration enabler 500 may provide SIFs 510 and DTIFs 520. The SIFs 510 and the DTIFs 520 illustrated in FIG. 5 are only examples for description, and embodiments are not limited thereto. For example, the integration enabler 500 may be implemented by excluding some of the SIFs 510 or the DTIFs 520 illustrated in FIG. 5 or by adding other functions.

The SIFs 510 may support integration between a metaverse system and a third-party service system. The DTIFs 520 may support integration between the metaverse system and a digital twin system.

The operations represented by the FEs illustrated in FIG. 5 may be performed by at least one component (e.g., a processor) of the integration enabler 500.

A SIM-FE 511 may provide a function for storing, managing, and providing metadata of third-party services. The SIM-FE 511 may support registration of service information of third-party service systems and may transmit the associated service metadata to the metaverse system through an SD-FE of the metaverse system. In addition, the SIM-FE 511 may serve as a registry and discovery backend that supports dynamic service interactions.

An authentication processing FE (AP-FE) 512 may provide a function for handling authentication requests from the metaverse system. The AP-FE 512 may forward the requests to appropriate third-party service systems through a service gateway structure to process the requests. The AP-FE 512 may interact with a protocol adaptation FE (PA-FE) 513 for compatibility as needed and may verify the authentication result before transmitting the authentication result back to an SA-FE of the metaverse system.

The PA-FE 513 may provide a function for converting communication protocols, encoding schemes, or interface structures between the metaverse system and third-party service systems. The PA-FE 513 may adapt protocol-level differences to support seamless interoperability between heterogeneous systems. In addition, the PA-FE 513 may operate as a support component that is invoked when the AP-FE 512 or a service bridging FE (SB-FE) 515 is required.

A message formatting FE (MF-FE) 514 may provide a function for formatting request messages and response messages to ensure structural compatibility and syntactic compatibility between the metaverse system and third-party services. The MF-FE 514 may be used by the SB-FE 515 whenever message-level conversion is required.

The SB-FE 515 may provide a function for bridging service requests from the metaverse system to a third-party service system. The SB-FE 515 may coordinate the flow of service invocation and may invoke the PA-FE 513 and the MF-FE 514 as needed to ensure appropriate communication. In addition, the SB-FE 515 may serve as a central bridging point between the systems.

A digital twin system information management FE (DTSIM-FE) 521 may provide a function for registering and managing metadata (e.g., provider name, system identification (ID), and access endpoint) associated with digital twin systems. The information may be used to identify and connect the digital twin systems on behalf of the metaverse system, enabling system-level integration and discovery.

A digital twin model metadata management FE (DTMMM-FE) 522 may provide a function for storing, managing, and transmitting metadata of digital twin models registered by digital twin systems. The metadata may support discovery by the metaverse system and may support users in selecting appropriate digital twins to be used in a metaverse.

A digital twin model bridging FE (DTMB-FE) 523 may provide a function for importing and exporting digital twin models between the metaverse system and a digital twin system. The DTMB-FE 523 may serve as a fundamental interface for model exchange and may invoke FEs for tasks such as authentication, format adaptation, and access control.

A synchronization support FE (SS-FE) 524 may provide a function for managing synchronization requests between virtual objects of a metaverse and corresponding physical objects managed by digital twin systems. The SS-FE 524 may receive synchronization triggers from the metaverse system and may route the synchronization triggers to an appropriate digital twin system through a physical synchronization FE. In this case, synchronization targets may include the state, position, operation, and other properties of an object.

For example, a VS-FE of the metaverse system may control a virtual object when a change of the virtual object needs to be reflected onto a physical object or when a change of the physical object needs to be reflected onto the virtual object. In addition, a PS-FE of a digital twin system may control a physical object when a change of the virtual object needs to be reflected onto the physical object or when a change of the physical object needs to be reflected onto the virtual object. The SS-FE 524 may support synchronization by connecting the VS-FE and the PS-FE when such reflection between virtual and physical objects is required and may serve as a manager for maintaining a history of synchronization requests.

In an embodiment, when an operation performed in a metaverse is reflected onto the real world, operations may be performed sequentially by a GF of the metaverse system, a VS-FE, an SS-FE, a PS-FE, and a GF of a digital twin system. In addition, when an operation performed in the real world is reflected onto the metaverse, operations may be performed sequentially by a GF of the digital twin system, a PS-FE, an SS-FE, a VS-FE, and a GF of the metaverse system.

A DTAC-FE 525 may provide a management function for enforcing access policies on digital twin model tasks, including import and export. The DTAC-FE 525 may verify access credentials by interacting with an AM-FE of a digital twin system and may notify the DTMB-FE 523 of an authentication result before permitting data exchange.

A format adaptation FE (FA-FE) 526 may provide a function for converting digital twin models across different data formats, schemas, or representations to ensure compatibility between a digital twin system and the metaverse system. The FA-FE 526 may be invoked by the DTMB-FE 523 when a format difference is detected.

A model validation FE (MV-FE) 527 may provide a function for verifying the validity of digital twin models during import and export processes. The MV-FE 527 may be invoked by the DTMB-FE 523 to verify model integrity and compliance with requirements.

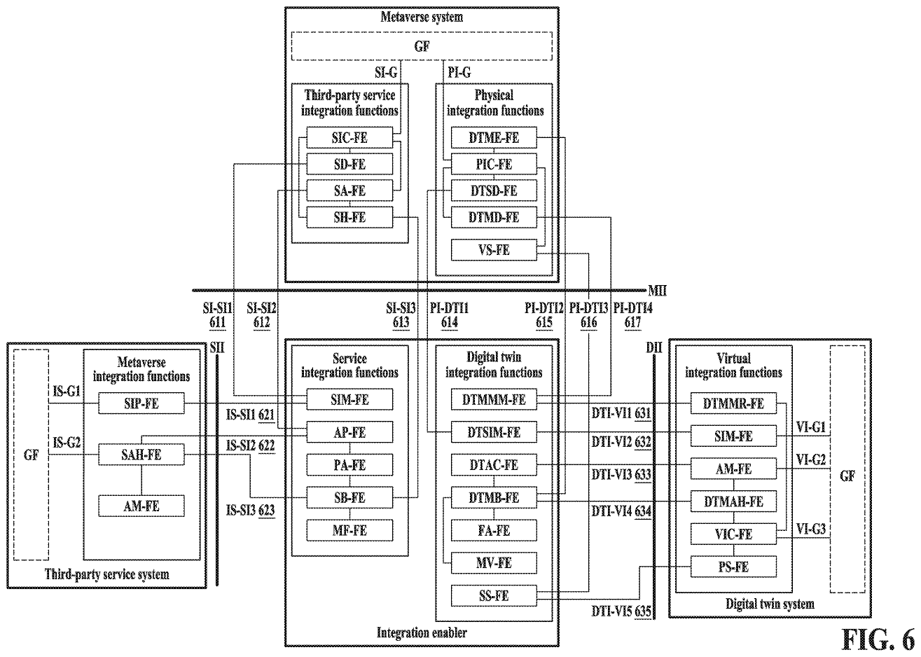

FIG. 6 is a diagram illustrating interfaces and reference points between an integration enabler, a metaverse system, a third-party service system, and a digital twin system according to an embodiment.

Referring to FIG. 6, a metaverse integration interface (MII) indicating an interface between the integration enabler and the metaverse system, a service integration interface (SII) indicating an interface between the integration enabler and the third-party service system, and a digital twin integration interface (DII) indicating an interface between the integration enabler and the digital twin system are illustrated as an example. The MII, the SII, and the DII may include various reference points that support interactions among associated FEs.

The MII may enable interaction between the integration enabler and the metaverse system. In addition, the MII may be used for the following tasks:
discovering available digital twin systems within the metaverse system;
discovering metadata of available digital twin models;
exchanging data required to use and register digital twins; and
exchanging synchronization-related data between digital twins and corresponding physical objects.

The SII may enable interaction between the integration enabler and the third-party service system. In addition, the SII may be used for the following tasks:
registering and managing third-party service information;
authenticating users for selected third-party services; and
exchanging service-related data between the third-party service system and the metaverse system.

The DII may enable interaction between the integration enabler and the digital twin system. In addition, the DII may be used for the following tasks:
registering digital twin system information;
registering digital twin model metadata;
exchanging data required to use and register digital twins; and
exchanging synchronization-related data between digital twins and corresponding physical objects.

A service integration-service integration 1 (SI-SI1) 611 may indicate a reference point between an SD-FE of the metaverse system and a SIM-FE of the integration enabler. The SI-SI1 611 may be used to discover available third-party services within the metaverse.

The metaverse system may request information regarding available types of third-party services from the integration enabler through the SI-SI1 611. The integration enabler may then provide information regarding third-party services registered with the integration enabler.

The SI-SI1 611 may support the following tasks:
initiating a service discovery request from an SD-FE to a SIM-FE, including optional filters such as categories, keywords, and compatibility criteria (e.g., service or data format versions);
discovering metadata of particular third-party services, including technical, operational, and service-level properties;
obtaining a categorized or hierarchical list of third-party service types to assist service catalog navigation; and
discovering the operational state of each service item, such as active, deprecated, or under maintenance, to support runtime decision-making.

An SI-SI2 612 may indicate a reference point between an SA-FE of the metaverse system and an AP-FE of the integration enabler. The SI-SI2 612 may be used to perform authentication tasks required to use third-party services within the metaverse.

The metaverse system may request authentication for a third-party service to be used through the SI-SI2 612 and may exchange necessary authentication data with the third-party service system.

The SI-SI2 612 may support the following tasks:
submitting authentication credentials (e.g., user ID, token, session key, device type, or location) from an SA-FE to an AP-FE to verify access rights for a selected third-party service;
receiving an authentication result (e.g., success, failure, or an error code) from an AP-FE to determine whether service access is approved; and
forwarding credentials or access tokens from an AP-FE to a corresponding third-party service system when delegated authentication is required.

An SI-SI3 613 may indicate a reference point between an SH-FE of the metaverse system and an SB-FE of the integration enabler. The SI-SI3 613 may be used to support the exchange of data required to use third-party services within the metaverse environment. The SB-FE may enhance compatibility between the associated systems by performing protocol adaptation, data format conversion, or other interworking functions as part of its bridging role.

The SI-SI3 613 may support the following tasks:
transmitting input data from the metaverse system to the third-party service system; and
receiving output data generated by the third-party service and forwarding it to the metaverse system.

A physical integration-digital twin integration 1 (PI-DT1) 614 may indicate a reference point between a DTSD-FE of the metaverse system and a DTSIM-FE of the integration enabler. The PI-DT1 614 may be used to support discovery of digital twin systems that manage digital twin models to be used in metaverse applications.

The metaverse system may discover information regarding registered digital twin systems through associated FEs using the PI-DT1 614. For example, the discovery process may include filtering based on system type, function, supported domains, or operational state.

The PI-DT1 614 may support the following tasks:
discovering a list of available digital twin systems associated with domain requirements or a particular service of the metaverse;
querying properties of each digital twin system (e.g., supported model types, communication protocols, update mechanisms, application domains, regions, real-time capabilities, or ownership); and
discovering system-level metadata such as system ID, registration timestamp, or operational organization.

According to an embodiment, the integration enabler, in response to a discovery request from the metaverse system, may provide at least one of model types supported by each digital twin system, communication protocols, update mechanisms, application domains, regions, real-time capabilities, and ownership to the metaverse system. In this case, a model type may be determined by categories such as animals or vehicles, by tasks such as design, assembly, or quality inspection, by companies, by components such as wheels, steering wheels, brakes, or engines, or by names. However, embodiments are not limited thereto, and a model type may be determined in various other forms.

A physical integration-digital twin integration 2 (PI-DTI2) 615 may indicate a reference point between a DTME-FE of the metaverse system and a DTMB-FE of the integration enabler. The PI-DTI2 615 may be used to support import and export of digital twin models between the metaverse system and the digital twin system.

The metaverse system may retrieve digital twin models from a digital twin system using the PI-DTI2 615 for use within the metaverse or may export digital twin models generated by a user in the metaverse to the digital twin system. Model exchange may include modifications adjusted based on entire model structures, partial components, or specific usage contexts.

The PI-DTI2 615 may support the following tasks:
transmitting and exporting digital twin models generated or modified by a user from the metaverse system to the digital twin system;
transmitting and importing digital twin models from the digital twin system to the metaverse system for visualization, simulation, or interaction;
supporting negotiation as a process of identifying mutually compatible model formats to ensure syntactic compatibility and semantic compatibility (e.g., CAD (computer aided design), JSON-LD (javascript object notation for linked data), FMI (functional mock up interface), or RDF (resource description framework)-based models); and
exchanging partial models or delta updates when transmission of an entire model is unnecessary or inefficient.

A PI-DTI3 616 may indicate a reference point between a VS-FE of the metaverse system and an SS-FE of the integration enabler. The PI-DTI3 616 may be used to support synchronization between digital twin models used in the metaverse and corresponding physical objects.

The metaverse system may receive real-time or near-real-time data from physical objects using the PI-DTI3 616 to update corresponding digital twin models and may transmit state or control data of the digital twin models to the physical objects as needed. The synchronization process may include unidirectional or bidirectional data flows depending on an application scenario.

The PI-DTI3 616 may support the following tasks:
receiving real-world data (e.g., sensor readings or event states) from physical objects to update the states of corresponding digital twin models; and
transmitting virtual state changes or control commands from digital twin models to the corresponding physical objects when permitted by the system configuration.

A PI-DTI4 617 may indicate a reference point between a DTMD-FE of the metaverse system and a DTMMM-FE of the integration enabler. The PI-DTI4 617 may be used to support discovery of information regarding digital twin models managed by a particular digital twin system selected by a user.

The metaverse system may request and receive metadata associated with available digital twin models in a selected digital twin system using the PI-DTI4 617. The metadata may include descriptive attributes that help a user understand the purpose, structure, domain relevance, and integration potential of the models in the metaverse.

The PI-DTI4 617 may support the following tasks:
discovering digital twin model metadata including model name, type, structure, version, and associated application domains;
discovering access control metadata (e.g., visibility level or required permissions) to support safe selection or integration; and
supporting browsing or page-by-page navigation of model metadata when multiple models are associated with a selected digital twin system.

Referring to FIG. 6, SI-G (service integration general function) may indicate a reference point between a SIC-FE of the metaverse system and GFs of the metaverse system. In addition, a PI-G reference point may indicate a reference point between a PIC-FE of the metaverse system and the GFs of the metaverse system.

An integration support-service integration 1 (IS-SI1) 621 may indicate a reference point between a SIP-FE of the third-party service system and a SIM-FE of the integration enabler. The IS-SI1 621 may be used to support registration and discovery of information regarding third-party service systems that provide services intended to be used in the metaverse environment.

The third-party service system may register service-related information, including metadata and operational descriptors, through the IS-SI1 621. The IS-SI1 621 may support discovery and management of previously registered service information.

The IS-SI1 621 may support the following tasks:
registering third-party service system information, including system name, service type, provider organization, and supported interfaces;
updating or modifying previously registered information to reflect changes in service configuration or operational state; and
deregistering third-party service systems when services are discontinued or unavailable.

An IS-SI2 622 may indicate a reference point between an SAH-FE of the third-party service system and an AP-FE of the integration enabler. The IS-SI2 622 may be used to support authentication of users attempting to access third-party services from the metaverse system. The third-party service system may verify the identity or credentials of users forwarded from the metaverse system through the IS-SI2 622.

The IS-SI2 622 may support the following tasks:
transmitting user authentication results (e.g., access tokens or assertions) from an AP-FE to an SAH-FE to verify service access rights;
providing additional authorization metadata, such as token expiration, scope, or user roles, to inform access control determinations on the third-party side;
selectively supporting federated authentication mechanisms; and
notifying an access result or denial from an SAH-FE to an AP-FE when required for session or policy management.

An IS-SI3 623 may indicate a reference point between an SAH-FE of the third-party service system and an SB-FE of the integration enabler. The IS-SI3 623 may be used to support the exchange of input and output data associated with third-party service execution triggered by the metaverse system.

The third-party service system may receive input data for service handling through the IS-SI3 623 and may return the service data as output. The SB-FE may perform protocol intermediation or data format adaptation to ensure interoperability between systems when the metaverse system and the third-party service system use heterogeneous communication mechanisms or data schemas.

The IS-SI3 623 may support the following tasks:
receiving input data (including user requests, parameters, or contextual information required to execute a third-party service) from an SB-FE to an SAH-FE; and
transmitting output data (including response results, generated content, or values computed based on third-party service logic) from an SAH-FE to an SB-FE.

Referring to FIG. 6, IS-G1 (integration support general function) may indicate a reference point between an SIP-FE of the third-party service system and GFs of the third-party service system. In addition, IS-G2 may indicate a reference point between an SAH-FE of the third-party service system and the GFs of the third-party service system.

A digital twin integration-virtual integration 1 (DTI-VI1) 631 may indicate a reference point between a DTMMR-FE of the digital twin system and a DTMMM-FE of the integration enabler. The DTI-VI1 631 may be used to support registration of information regarding digital twin models managed by the digital twin system.

The digital twin system may submit metadata describing characteristics and usage contexts of corresponding models through the DTI-VI1 631. The metadata may enable discovery and use of the models by metaverse systems through associated FEs and appropriate discovery and selection mechanisms.

The DTI-VI1 631 may support the following tasks:
submitting digital twin model metadata including model ID, name, version, structure type, applicable domains, and supported functions;
updating or modifying existing model metadata to reflect changes such as version upgrades, updated descriptions, or compatibility details; and
deregistering model metadata that is no longer maintained, invalid, or publicly accessible.

A DTI-VI2 632 may indicate a reference point between a SIM-FE of the digital twin system and a DTSIM-FE of the integration enabler. The DTI-VI2 632 may be used to support registration of information regarding a digital twin system that manages digital twin models to be potentially used in the metaverse.

The digital twin system may provide operational descriptors and system-level metadata describing a system ID, functions, and supported application domains through the DTI-VI2 632. The DTI-VI2 632 may enable the system to be discovered and used in scenarios in which digital twin models are accessed or exchanged with the metaverse through associated functions.

The DTI-VI2 632 may support the following tasks:
submitting digital twin system information including a system name, system ID, provider organization, supported application domains, or communication interfaces;
discovering usage-related data such as model availability state, generation and update timestamps, or past usage contexts;
updating or modifying previously registered system information to reflect changes in functions, operational states, or technical configurations; and
deregistering digital twin systems that are no longer active or that do not participate in digital twin integration with the metaverse.

A DTI-VI3 633 may indicate a reference point between an AM-FE of the digital twin system and a DTAC-FE of the integration enabler. The DTI-VI3 633 may be used to support mapping and verifying authentication credentials required to access a digital twin selected by a user through the metaverse.

Authentication credentials obtained from a metaverse-side environment may be transmitted to the digital twin system through the DTI-VI3 633 and interpreted according to local authentication mapping rules. The DTI-VI3 633 may enable cross-domain or federated access to digital twins managed by external systems.

The DTI-VI3 633 may support the following tasks:
transmitting authentication credentials or tokens from a DTAC-FE to an AM-FE for identity verification; and
returning an authentication result (e.g., mapped identity or success/failure) to a DTAC-FE.

A DTI-VI4 634 may indicate a reference point between a DTMAH-FE of the digital twin system and the DTMB-FE of the integration enabler. The DTI-VI4 634 may be used to import and export digital twin models between the digital twin system and the metaverse system.

Digital twin models may be imported from the metaverse system to the digital twin system through the DTI-VI4 634 (e.g., a user-generated model) or may be exported from the digital twin system for use in the metaverse. Associated functions may handle model conversion, compatibility, and validation to ensure consistency across system environments.

The DTI-VI4 634 may support the following tasks:
transmitting and importing digital twin models to the digital twin system. In this case, models may be transmitted from a DTMB-FE to a DTMAH-FE based on user upload or selection in the metaverse; and
transmitting and exporting a digital twin model from the digital twin system. In this case, models may be transmitted from a DTMAH-FE to a DTMB-FE to be transmitted to the metaverse system.

A DTI-VI5 635 may indicate a reference point between a PS-FE of the digital twin system and an SS-FE of the integration enabler. The DTI-VI5 635 may be used to support synchronization between digital twin models used in the metaverse and corresponding physical objects managed by the digital twin system.

Data flows associated with detection, control, and state updates may be exchanged through the DTI-VI5 635 to ensure consistency between the physical state of an actual physical object and digital representations used in the metaverse. A synchronization process may include real-time or periodic updates, directional control, and time-sensitive data processing.

The DTI-VI5 635 may support the following tasks:
transmitting physical-object state data from a PS-FE to an SS-FE to update a corresponding digital twin in the metaverse; and
receiving control commands or state requests at a PS-FE from an SS-FE to monitor or influence the operation of a physical object based on virtual interactions.

Referring to FIG. 6, VI-G1 (virtual integration general function) may indicate a reference point between a SIM-FE of the digital twin system and GFs of the digital twin system. VI-G2 may indicate a reference point between an AM-FE of the digital twin system and the GFs of the digital twin system. VI-G3 may indicate a reference point between a VIC-FE of the digital twin system and the GFs of the digital twin system.

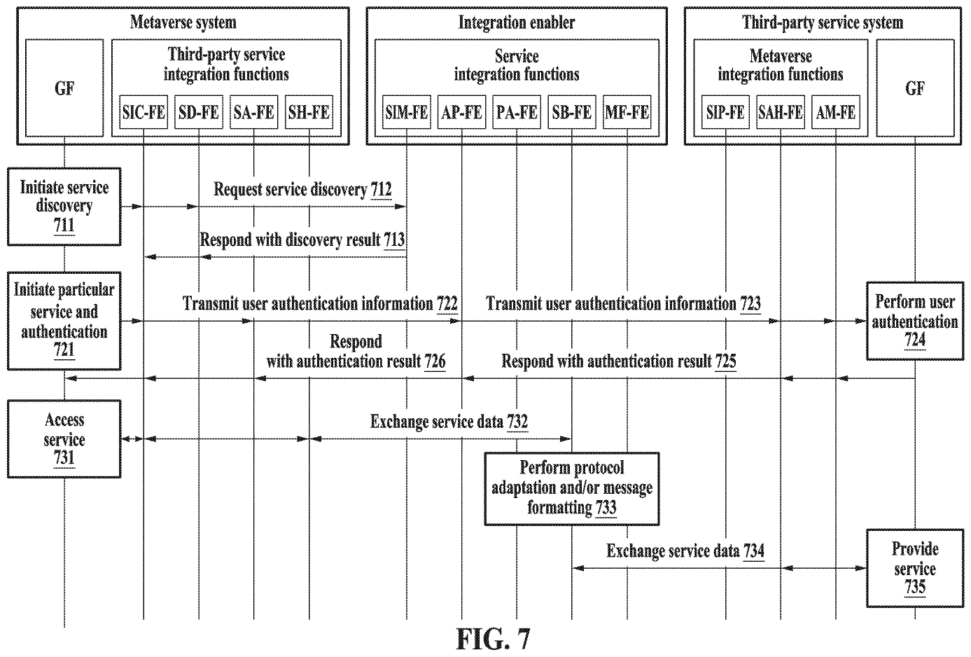

FIG. 7 is a diagram illustrating an operation flow of an integration enabler for integrating a third-party service system and a metaverse system according to an embodiment.

Referring to FIG. 7, an operation flow in which the integration enabler integrates third-party services into the metaverse system is illustrated as an example. In FIG. 7, for ease of description, each operation is illustrated and described as being performed by corresponding FEs, but, according to embodiments, the operations may be performed by an apparatus or a system (e.g., the metaverse system, the integration enabler, or the third-party service system) including the corresponding FEs.

In the following embodiments, operations may be performed sequentially but not necessarily. For example, the order of the operations may be changed and at least two of the operations may be performed in parallel. Operations 711 to 734 may each be performed by at least one component (e.g., a processor) of the metaverse system, the integration enabler, or the third-party service system.

In operation 711, the metaverse system may discover third-party service systems that satisfy specified criteria and may initiate a service discovery request through its SIC-FE and SD-FE.

In operation 712, the SD-FE of the metaverse system may transmit the service discovery request to the SIM-FE of the integration enabler.

In operation 713, the SIM-FE of the integration enabler may provide, as a response, a list of available third-party services that match the discovery criteria, and the metaverse system may receive the discovery result. For example, the discovery criteria may correspond to criteria requested by the metaverse system.

In operation 721, a user may select a particular service and may initiate an authentication process through an SA-FE of the metaverse system.

In operation 722, the SA-FE of the metaverse system may transmit user authentication information to an AP-FE of the integration enabler.

In operation 723, the AP-FE of the integration enabler may forward the authentication information to an SAH-FE of the third-party service system.

In operation 724, the third-party service system may process user authentication using its internal mechanisms.

In operation 725, an authentication result may be returned from the third-party service system to the AP-FE of the integration enabler.

In operation 726, the AP-FE of the integration enabler may return the authentication result to associated FEs of the metaverse system.

In operation 731, upon successful authentication, the user may access a selected third-party service through the metaverse system.

In operation 732, an SH-FE of the metaverse system may exchange service data with an SB-FE of the integration enabler.

In operation 733, the SB-FE of the integration enabler may perform selective protocol adaptation and/or message formatting.

In operation 734, the SB-FE of the integration enabler may exchange the adapted service data with the SAH-FE of the third-party service system.

In operation 735, the third-party service system may provide the selected service to the user.

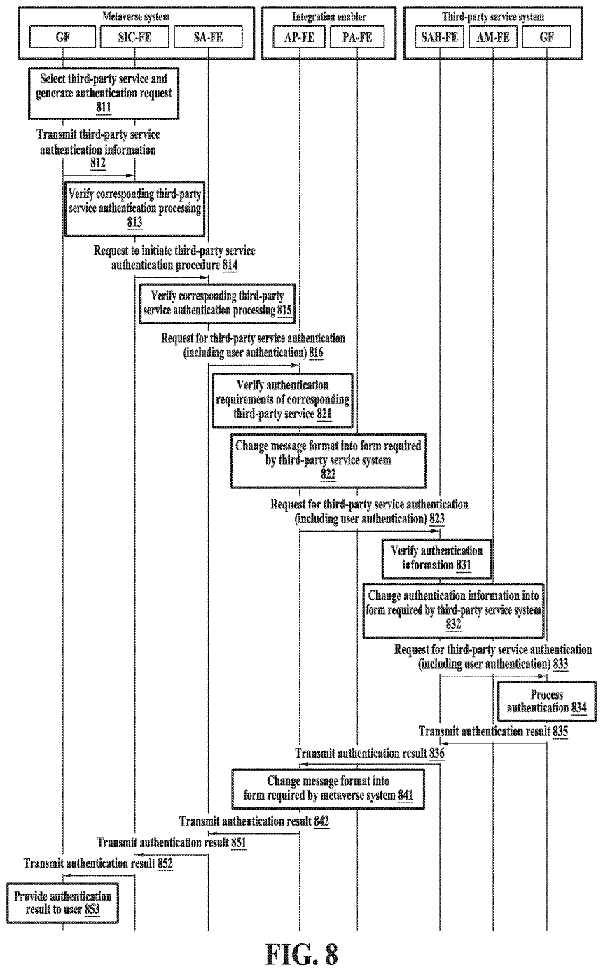

FIG. 8 is a diagram illustrating an operation flow of authenticating a user of a metaverse system to receive a third-party service according to an embodiment.

Referring to FIG. 8, an operation flow of authenticating a user of a metaverse system by an integration enabler interacting with a third-party service is illustrated as an example. In FIG. 8, for ease of description, each operation is illustrated and described as being performed by corresponding FEs, but, according to embodiments, the operations may be performed by an apparatus or a system (e.g., the metaverse system, the integration enabler, or the third-party service system) including the corresponding FEs.

In the following embodiments, operations may be performed sequentially but not necessarily. For example, the order of the operations may be changed and at least two of the operations may be performed in parallel. Operations 811 to 853 may each be performed by at least one component (e.g., a processor) of the metaverse system, the integration enabler, or the third-party service system.

In operation 811, the metaverse system may receive a request to use a third-party service selected by a user. For example, the metaverse system may receive the request to use the third-party service selected by a user from a user terminal. The third-party service selected by the user may be any of the third-party services discovered by the integration enabler and provided to the user. In an embodiment, the metaverse system may generate an authentication request for the user to access the third-party service based on the request to use the third-party service. Alternatively, the metaverse system may receive an authentication request from a user device to access the third-party service. Operation 811 may be performed by GFs and/or a SIC-FE of the metaverse system.

In operation 812, the GFs of the metaverse system may transmit third-party service authentication information in response to the authentication request to the SIC-FE. The third-party service authentication information may include pieces of information required to access the third-party service. For example, the third-party service authentication information may include authentication credentials or tokens, but embodiments are not limited thereto.

In operation 813, the SIC-FE of the metaverse system may receive the third-party service authentication information and may verify the processing of the received third-party service authentication information. For example, in response to receiving the third-party service authentication information, the SIC-FE may determine whether the interaction with external third-party service systems is required.

In operation 814, the SIC-FE of the metaverse system may request an SA-FE to initiate a third-party service authentication procedure. For example, the SIC-FE of the metaverse system may request the SA-FE to initiate the third-party service authentication procedure in response to determining that the interaction with the external third-party service systems is required.

In operation 815, the SA-FE of the metaverse system may verify the processing of the third-party service authentication information.

In operation 816, the SA-FE of the metaverse system may request an AP-FE of the integration enabler to authenticate the third-party service. The SA-FE of the metaverse system may transmit authentication information for the user to the AP-FE of the integration enabler together with the authentication request.

In operation 821, the AP-FE of the integration enabler may verify authentication requirements of the third-party service.

In operation 822, the integration enabler may determine whether to change a format of a message into a format required by the third-party service system based on the authentication requirements of the third-party service. The integration enabler may change the format of the message including the authentication information based on the authentication requirements, in response to determining that the format of the message is to be changed. Operation 822 may be performed by the AP-FE and/or PA-FE of the integration enabler.

In operation 823, the AP-FE of the integration enabler may transmit the authentication request of the third-party service to an SAH-FE of the third-party service system.

In operation 831, the SAH-FE of the third-party service system may receive the authentication request from the integration enabler and verify the authentication information included in the authentication request. The SAH-FE of the third-party service system may mediate communication between FEs included in the third-party service system depending on the type and purpose of the authentication request.

In operation 832, the third-party service system may determine whether to change the authentication information into the form required by the third-party service system. In response to determining that the authentication information is to be changed, the third-party service system may change the authentication information into the form required by the third-party service system. For example, the third-party service system may change the authentication credentials or tokens included in the authentication information. Operation 832 may be performed by the SAH-FE and/or AM-FE of the third-party service system.

In operation 833, the SAH-FE of the third-party service system may transmit the authentication request of the third-party service to a GF. The authentication request may include authentication information of the user.

In operation 834, the GF of the third-party service system may perform user authentication for the third-party service based on the authentication request. The GF of the third-party service system may perform the user authentication based on the authentication credentials or tokens included in the authentication information. The user authentication may be performed through an internal authentication mechanism of the third-party service system. For example, the third-party service system may perform the user authentication in various ways depending on the requirements of each third-party service system.

In operation 835, the GF of the third-party service system may transmit an authentication result of the user authentication to the SAH-FE. The authentication result may include at least one of authentication success or failure, access tokens, and assertions.

In operation 836, the SAH-FE of the third-party service system may transmit the authentication result to the AP-FE of the integration enabler.

In operation 841, the integration enabler may determine whether to change a format of a message including the authentication result into a format required by the metaverse system. The integration enabler may change the format of the message including the authentication result based on the requirements in response to determining that the format of the message is to be changed. Operation 841 may be performed by the AP-FE and/or PA-FE of the integration enabler.

In operation 842, the AP-FE of the integration enabler may transmit the authentication result to the SA-FE of the metaverse system.

In operation 851, the SA-FE of the metaverse system may transmit the authentication result received from the integration enabler to the SIC-FE.

In operation 852, the SIC-FE of the metaverse system may transmit the authentication result to the GF.

In operation 853, the GF of the metaverse system may provide the authentication result to the user. The user may receive the selected third-party service through the metaverse system based on the authentication result.

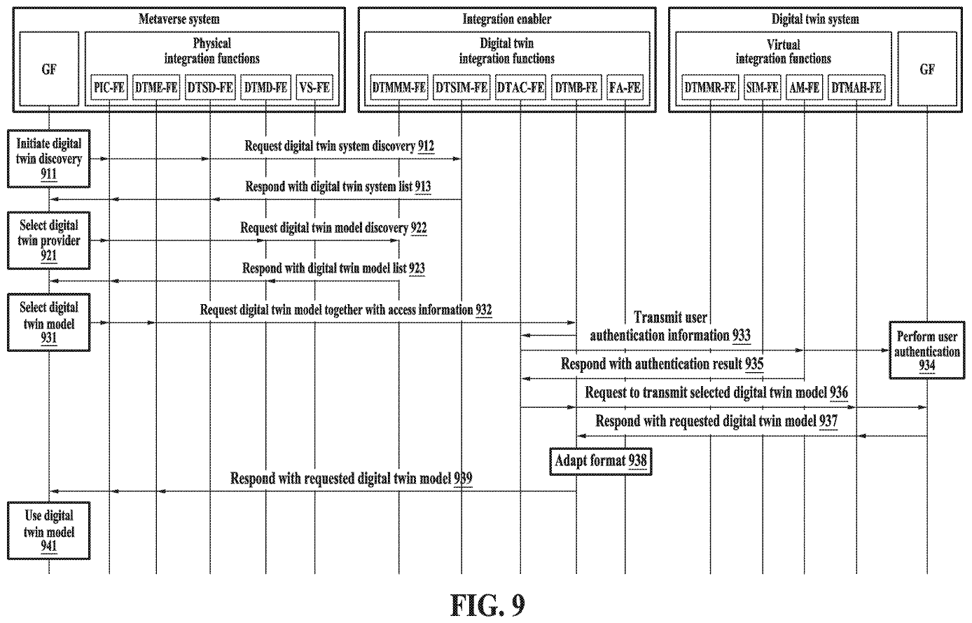

FIG. 9 is a diagram illustrating an operation flow of an integration enabler for integrating a digital twin system and a metaverse system according to an embodiment.

Referring to FIG. 9, an operation flow in which the integration enabler integrates a digital twin into the metaverse system is illustrated as an example. In FIG. 9, for ease of description, each operation is illustrated and described as being performed by corresponding FEs, but, according to embodiments, the operations may be performed by an apparatus or a system (e.g., the metaverse system, the integration enabler, or the digital twin system) including the corresponding FEs.

In the following embodiments, operations may be performed sequentially but not necessarily. For example, the order of the operations may be changed and at least two of the operations may be performed in parallel. Operations 911 to 941 may each be performed by at least one component (e.g., a processor) of the metaverse system, the integration enabler, or the digital twin system.

In operation 911, the metaverse system may initiate a discovery process to discover available digital twin systems. Operation 911 may correspond to a user task to find potential digital twin providers (e.g., digital twin systems).

In operation 912, a DTSD-FE of the metaverse system may transmit a discovery request to the DTSIM-FE of the integration enabler to discover available digital twin systems.

In operation 913, the DTSIM-FE of the integration enabler may transmit, as a response, a list of registered digital twin systems to the metaverse system.

In operation 921, the metaverse system may select a particular digital twin provider from the list. Operation 921 may correspond to a user selection.

In operation 922, the metaverse system may transmit, through a DTMD-FE, a request to the DTMMM-FE of the integration enabler to discover digital twin models managed by the selected digital twin system.

In operation 923, the DTMMM-FE of the integration enabler may transmit a list of registered digital twin models as a response.

In operation 931, the metaverse system may select a particular digital twin model from the list. Operation 931 may correspond to a user selection based on the discovery result.

In operation 932, the metaverse system may transmit an access request, including access information, to a DTMB-FE of the integration enabler through a DTME-FE.

In operation 933, a DTAC-FE of the integration enabler may transmit user authentication information to an AM-FE of the digital twin system to perform user authentication.

In operation 934, the digital twin system may perform user authentication.

In operation 935, the AM-FE of the digital twin system may transmit a response to the DTAC-FE of the integration enabler as an authentication result.

In operation 936, upon successful authentication, the DTMB-FE of the integration enabler may transmit a transmission request of a selected digital twin model to a DTMAH-FE of the digital twin system.

In operation 937, the digital twin system may return the requested digital twin model to the DTMB-FE of the integration enabler through the DTMAH-FE.

In operation 938, the DTMB-FE of the integration enabler may perform format adaptation selectively as needed.

In operation 939, the digital twin model may be transmitted from the DTMB-FE of the integration enabler to the DTME-FE of the metaverse system.

In operation 941, the metaverse system may activate user interaction using the discovered digital twin model or may provide associated services in a virtual environment.

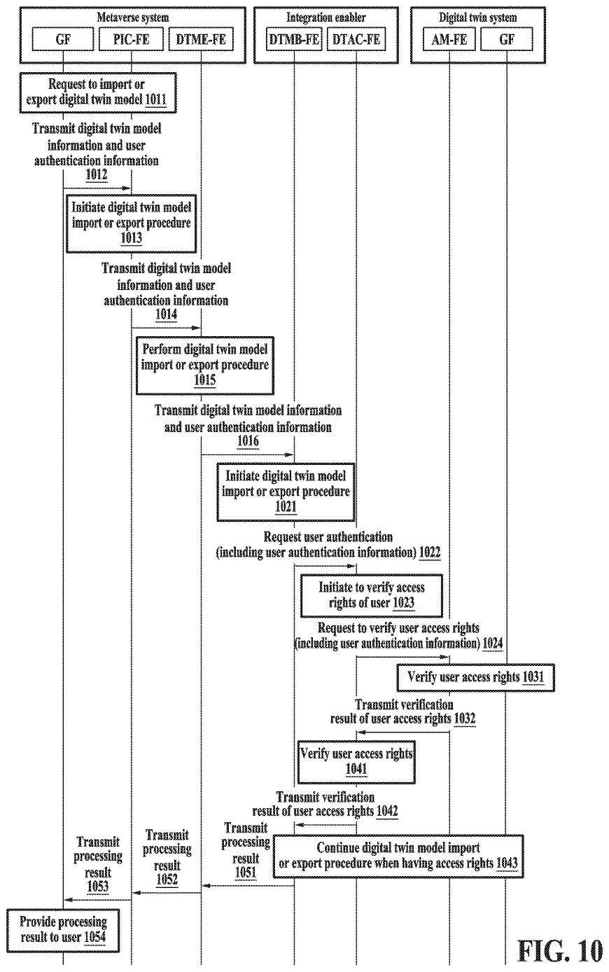

FIG. 10 is a diagram illustrating an operation flow of authenticating a user of a metaverse system to receive a digital twin model according to an embodiment.

Referring to FIG. 10, an operation flow in which an integration enabler authenticates a user of a metaverse system by interacting with a digital twin system is illustrated as an example. In FIG. 10, for ease of description, each operation is illustrated and described as being performed by corresponding FEs, but, according to embodiments, the operations may be performed by an apparatus or a system (e.g., the metaverse system, the integration enabler, or the digital twin system) including the corresponding FEs.

In the following embodiments, operations may be performed sequentially but not necessarily. For example, the order of the operations may be changed and at least two of the operations may be performed in parallel. Operations 1011 to 1054 may each be performed by at least one component (e.g., a processor) of the metaverse system, the integration enabler, or the digital twin system.

In operation 1011, the metaverse system may generate a request to import or export a digital twin model selected by a user. The digital twin model selected by the user may be a digital twin model included in a digital twin model list retrieved by the integration enabler and provided to the user. In an embodiment, based on a request to use a digital twin model of the user, the metaverse system may generate a request for the user to import the digital twin model. Alternatively, the metaverse system may generate a request to export a digital twin model modified by a user device. The request may include a user authentication request to access a digital twin model managed by a digital twin system. Operation 1011 may be performed by GFs and/or a PIC-FE of the metaverse system.

In operation 1012, the GF of the metaverse system may transmit, to the PIC-FE, a request to import or export the digital twin model. The GF of the metaverse system may transmit, to the PIC-FE, information on the digital twin model and user authentication information together with the request.

In operation 1013, the PIC-FE of the metaverse system may initiate an import or export procedure of the digital twin model. For example, the PIC-FE of the metaverse system may initiate the import or export procedure of the digital twin model in response to receiving the request to import or export the digital twin model.

In operation 1014, the PIC-FE of the metaverse system may transmit, to a DTME-FE, the received information on the digital twin model and user authentication information.

In operation 1015, the DTME-FE of the metaverse system may perform the import or export procedure of the digital twin model. The DTME-FE may serve as an interface for importing or exporting a digital twin model.

In operation 1016, the DTME-FE of the metaverse system may transmit the received information on the digital twin model and user authentication information to a DTMB-FE of the integration enabler.

In operation 1021, the DTMB-FE of the integration enabler may initiate the import or export procedure of the digital twin model in response to receiving the information on the digital twin model and the user authentication information.

In operation 1022, the DTMB-FE of the integration enabler may transmit the user authentication request for accessing the digital twin model to a DTAC-FE. The user authentication request may include the user authentication information.

In operation 1023, the DTAC-FE of the integration enabler may initiate verification of access rights of the user in response to receiving the user authentication request. The DTAC-FE of the integration enabler may enforce defined access policies for tasks for the digital twin model.

In operation 1024, the DTAC-FE of the integration enabler may transmit the verification of the access rights of the user to an AM-FE of the digital twin system.

In operation 1031, the digital twin system may verify the access rights of the user based on the user authentication information in response to the user authentication request. The AM-FE of the digital twin system may perform the user authentication based on authentication credentials or tokens included in the authentication information. For example, the AM-FE of a digital twin system may verify the access rights of the user by mapping the authentication credentials received from the integration enabler to internal authentication schemes. The digital twin system may perform the user authentication in various ways depending on the requirements of each digital twin system. Operation 1031 may be performed by the AM-FE and/or GF of the digital twin system.

In operation 1032, the AM-FE of the digital twin system may transmit a verification result of the access rights of the user to the DTAC-FE of the integration enabler. In the disclosure, for ease of description, the verification result of the access rights of the user may be referred to as a user authentication result.

In operation 1041, the DTAC-FE of the integration enabler may verify the access rights of the user.

In operation 1042, the DTAC-FE of the integration enabler may transmit the verification result of the access rights of the user to the DTMB-FE.

In operation 1043, the integration enabler and digital twin system may continue the import or export procedure of the digital twin model in response to determining that the user has the access rights based on the verification result of the access rights of the user.

In operation 1051, the DTMB-FE of the integration enabler may transmit a processing result of the import or export of the digital twin model to the DTME-FE of the metaverse system.

In operation 1052, the DTME-FE of the metaverse system may transmit the processing result of the import or export of the digital twin model to the PIC-FE.

In operation 1053, the PIC-FE of the metaverse system may transmit the processing result of the import or export of the digital twin model to the GF.

In operation 1054, the GF of the metaverse system may provide the user with the processing result of the import or export of the digital twin model.

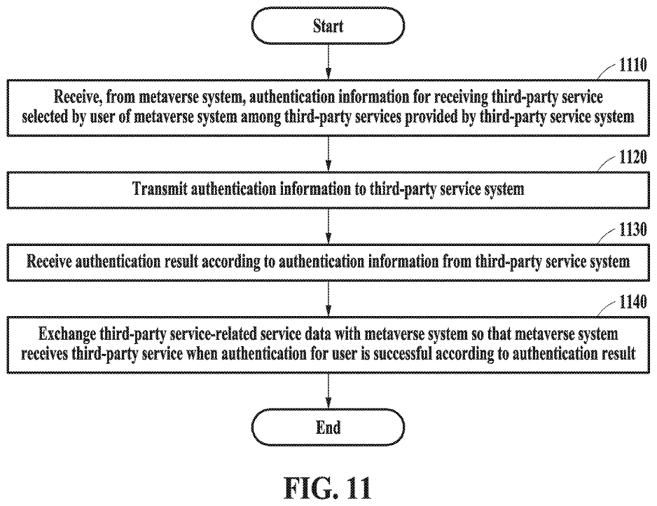

FIG. 11 is a flowchart illustrating a method of operating an integration enabler for authenticating a user by interacting with a third-party service system according to an embodiment.

In the following embodiments, operations may be performed sequentially but not necessarily. For example, the order of the operations may be changed and at least two of the operations may be performed in parallel. Operations 1110 to 1140 may be performed by at least one component (e.g., a processor) of the integration enabler.

In operation 1110, the integration enabler may receive, from a metaverse system, authentication information to receive a third-party service selected by a user of the metaverse system among third-party services provided by a third-party service system.

In operation 1120, the integration enabler may transmit the authentication information to the third-party service system. The integration enabler may verify access rights to the third-party service by interacting with the metaverse system. The integration enabler may transmit authentication credentials or tokens for verifying access rights of the user to the third-party service system. The authentication credentials and the tokens may be converted into a format required by the third-party service system. The integration enabler may verify authentication requirements for the third-party service, change a format of a message including the authentication information based on the authentication requirements, and transmit the changed message to the third-party service system.

In operation 1130, the integration enabler may receive an authentication result based on the authentication information from the third-party service system. The integration enabler may receive, from the third-party service system, an authentication result including access tokens and assertions for the third-party service according to the authentication credentials or tokens. The integration enabler may receive authorization metadata including at least one of token expiration, scope, or user roles to inform access control determinations of the third-party service system. The authentication result may include at least one of access tokens and assertions for the third-party service.

In operation 1140, when authentication for the user is successful based on the authentication result, the integration enabler may exchange service data for the third-party service with the metaverse system so that the metaverse system receives the third-party service. The integration enabler may exchange the service data with the metaverse system by converting a communication protocol between the metaverse system and the third-party service system.

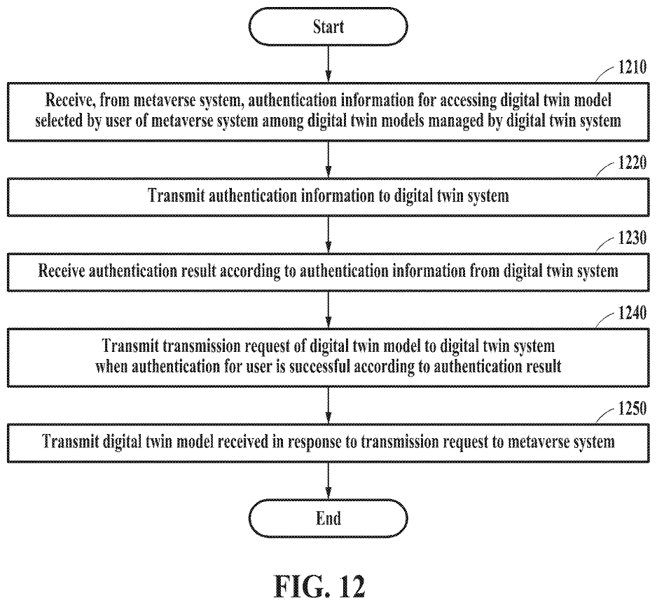

FIG. 12 is a flowchart illustrating a method of operating an integration enabler for authenticating a user by interacting with a digital twin system according to an embodiment.

In the following embodiments, operations may be performed sequentially but not necessarily. For example, the order of the operations may be changed and at least two of the operations may be performed in parallel. Operations 1210 to 1250 may be performed by at least one component (e.g., a processor) of the integration enabler.

In operation 1210, the integration enabler may receive, from a metaverse system, authentication information for accessing a digital twin model selected by a user of the metaverse system among digital twin models managed by a digital twin system.

In operation 1220, the integration enabler may transmit the authentication information to the digital twin system. The integration enabler may verify access rights to the digital twin system by interacting with the digital twin system. The integration enabler may transmit authentication credentials or tokens for identity verification of a user to the digital twin system, and receive, from the digital twin system, an authentication result including identity mapped to the user and authentication success or failure, based on the authentication credentials or tokens.

In operation 1230, the integration enabler may receive the authentication result based on the authentication information from the digital twin system.

In operation 1240, the integration enabler may transmit a transmission request of the digital twin model to the digital twin system when the authentication for the user is successful based on the authentication result. The integration enabler may determine whether a format of the digital twin system and the metaverse system is different from each other, and change the format of a selected digital twin model and transmit the changed digital twin model to the metaverse system in response to determining that the format is different from each other.

In operation 1250, the integration enabler may transmit the digital twin model received in response to the transmission request to the metaverse system.

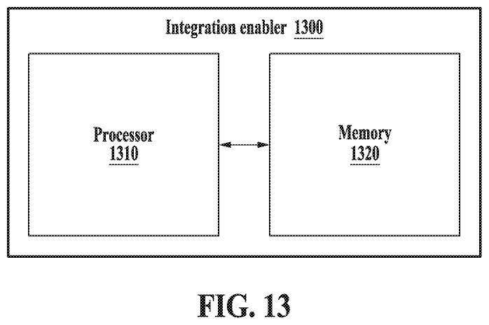

FIG. 13 is a block diagram illustrating an integration enabler according to an embodiment.

Referring to FIG. 13, an integration enabler 1300 may include a processor 1310. The processor 1310 may include at least one processor. In addition, the integration enabler 1300 may further include memory 1320.

The memory 1320 may store instructions (e.g., programs) executable by the processor 1310. For example, the instructions may include instructions for performing the operation of the processor 1310 and/or the operation of each component of the processor 1310.

The processor 1310 may be a device for executing instructions or programs or controlling the integration enabler 1300, and may include, for example, various processors, such as a CPU or a graphics processing unit (GPU). The processor 1310 may receive, from a metaverse system, authentication information to receive a third-party service selected by a user of the metaverse system among third-party services provided by a third-party service system. The processor 1310 may transmit the authentication information to the third-party service system. The processor 1310 may receive an authentication result based on the authentication information from the third-party service system. When authentication for the user is successful based on the authentication result, the processor 1310 may exchange service data for the third-party service with the metaverse system so that the metaverse system receives the third-party service.

The processor 1310 may verify access rights to the third-party service by interacting with the metaverse system. The processor 1310 may transmit authentication credentials or tokens for verifying access rights of the user to the third-party service system, and may receive, from the third-party service system, an authentication result including access tokens and assertions for the third-party service according to the authentication credentials or tokens. The processor 1310 may receive authorization metadata including at least one of token expiration, scope, or user roles to inform access control determinations of the third-party service system. The processor 1310 may verify authentication requirements for the third-party service, change a format of a message including the authentication information based on the authentication requirements, and transmit the changed message to the third-party service system. The processor 1310 may exchange the service data with the metaverse system by converting a communication protocol between the metaverse system and the third-party service system.

The processor 1310 may receive, from the metaverse system, authentication information for accessing a digital twin model selected by a user of the metaverse system among digital twin models managed by a digital twin system. The processor 1310 may transmit the authentication information to the digital twin system. The processor 1310 may receive an authentication result based on the authentication information from the digital twin system. The processor 1310 may transmit a transmission request of the digital twin model to the digital twin system when the authentication for the user is successful based on the authentication result. The processor 1310 may transmit the digital twin model received in response to the transmission request to the metaverse system.

The processor 1310 may verify access rights to the digital twin system by interacting with the digital twin system. The processor 1310 may transmit authentication credentials or tokens for identity verification of a user to the digital twin system, and receive, from the digital twin system, an authentication result including an identity mapped to the user and authentication success or failure, based on the authentication credentials or the tokens. The processor 1310 may determine whether a format of the digital twin system and the metaverse system is different from each other, and change the format of a selected digital twin model and transmit the changed digital twin model to the metaverse system in response to determining that the format is different from each other.

The embodiments described herein may be implemented using hardware components, software components, or a combination thereof. For example, the device, the method, and the components described in the embodiments may be implemented using a general-purpose or special-purpose computer, such as a processor, a controller and an arithmetic logic unit (ALU), a digital signal processor (DSP), a microcomputer, a FPGA, a programmable logic unit (PLU), a microprocessor, or any other devices capable of responding to and executing instructions. A processing device may run an operating system (OS) and a software application that runs on the OS. The processing device may also access, store, manipulate, process, and generate data in response to execution of software. For purpose of simplicity, the description of a processing device is used as singular; however, one skilled in the art will appreciate that a processing device may include a plurality of processing elements and/or a plurality of types of processing elements. For example, the processing device may include a plurality of processors or a single processor and a single controller. In addition, different processing configurations are possible, such as parallel processors.

The software may include a computer program, a piece of code, an instruction, or some combination thereof, to independently or collectively instruct or configure the processing device to operate as desired. Software and/or data may be stored in any type of machine, component, physical or virtual equipment, or computer storage medium or device capable of providing instructions or data to or being interpreted by the processing device. The software may also be distributed over network-coupled computer systems so that the software is stored and executed in a distributed fashion. The software and data may be stored by one or more non-transitory computer-readable recording media.

The method according to the embodiments described above may be recorded in non-transitory computer-readable storage media including program instructions to implement various operations of the embodiments described above. The non-transitory computer-readable storage media may also store, alone or in combination with the program instructions, data files, data structures, and the like. The program instructions recorded on the media may be those specially designed and constructed for the purposes of embodiments, or they may be of the kind well-known and available to those having skill in the computer software arts. Examples of non-transitory computer-readable storage media include magnetic media such as hard disks, floppy disks, and magnetic tape; optical media such as compact disc read-only memory (CD-ROM) discs and digital video discs (DVDs); magneto-optical media such as floptical disks; and hardware devices that are specifically configured to store and perform program instructions, such as ROM, random-access memory (RAM), flash memory, and the like. Examples of program instructions include both machine code, such as produced by a compiler, and files containing higher-level code that may be executed by the computer using an interpreter.

The hardware devices described above may be configured to act as one or more software modules in order to perform the operations of the embodiments described above, or vice versa.

As described above, although the embodiments have been described with reference to the limited drawings, one of ordinary skill in the art may apply various technical modifications and variations based thereon. For example, suitable results may be achieved if the described techniques are performed in a different order, and/or if components in a described system, architecture, device, or circuitry are combined in a different manner, or replaced or supplemented by other components or their equivalents.

Therefore, other implementations, other embodiments, and equivalents to the claims are also within the scope of the following claims.

What is claimed is:

1. A method of operating an integration enabler, the method comprising:
receiving, from a metaverse system, authentication information to receive a third-party service selected by a user of the metaverse system among third-party services provided by a third-party service system;
transmitting the authentication information to the third-party service system;
receiving an authentication result based on the authentication information from the third-party service system; and
when authentication for the user is successful based on the authentication result, exchanging service data for the third-party service with the metaverse system so that the metaverse system receives the third-party service.

2. The method of claim 1, wherein the transmitting of the authentication information to the third-party service system comprises verifying access rights to the third-party service by interacting with the metaverse system.

3. The method of claim 1, wherein the transmitting of the authentication information to the third-party service system comprises:
transmitting authentication credentials or tokens for verifying access rights of the user to the third-party service system; and
receiving an authentication result based on the authentication credentials or the tokens from the third-party service system.

4. The method of claim 3, wherein the authentication credentials and the tokens are changed into a format required by the third-party service system.

5. The method of claim 1, wherein the receiving of the authentication result from the third-party service system comprises receiving authorization metadata comprising at least one of token expiration, scope, or user roles to inform access control determinations of the third-party service system.

6. The method of claim 1, wherein the transmitting of the authentication information to the third-party service system comprises:
verifying authentication requirements for the third-party services; and
changing a format of a message comprising the authentication information based on the authentication requirements and transmitting the changed message to the third-party service system.

7. The method of claim 1, wherein the exchanging of the service data with the metaverse system comprises exchanging the service data with the metaverse system by converting a communication protocol between the metaverse system and the third-party service system.

8. The method of claim 1, wherein the authentication result comprises at least one of access tokens and assertions for the third-party service.

9. A method of operating an integration enabler, the method comprising:
receiving, from a metaverse system, authentication information for accessing a digital twin model selected by a user of the metaverse system among digital twin models managed by a digital twin system;
transmitting the authentication information to the digital twin system;
receiving an authentication result based on the authentication information from the digital twin system;
when authentication for the user is successful based on the authentication result, transmitting a transmission request of the digital twin model to the digital twin system; and
transmitting the digital twin model received in response to the transmission request to the metaverse system.

10. The method of claim 9, wherein the transmitting of the authentication information to the digital twin system comprises verifying access rights to the digital twin system by interacting with the digital twin system.

11. The method of claim 9, wherein the transmitting of the authentication information to the digital twin system comprises:
transmitting authentication credentials or tokens for verifying an identity of the user to the digital twin system; and
receiving, from the digital twin system, an authentication result comprising an identity mapped to the user and authentication success or failure, based on the authentication credentials or the tokens.

12. The method of claim 9, wherein the transmitting of the digital twin model to the metaverse system comprises:
determining whether a format of the digital twin system and the metaverse system is different from each other; and
changing the format of the selected digital twin model and transmitting the changed digital twin model to the metaverse system, in response to determining that the format is different from each other.

13. A non-transitory computer-readable storage medium storing instructions that, when executed by a processor, cause the processor to perform the method of claim 1.

14. An integration enabler comprising:
a processor; and
memory storing instructions,
wherein the instructions, when executed by the processor, cause the integration enabler to:
receive, from a metaverse system, authentication information to receive a third-party service selected by a user of the metaverse system among third-party services provided by a third-party service system;
transmit the authentication information to the third-party service;
receive an authentication result based on the authentication information from the third-party service system; and
when authentication for the user is successful based on the authentication result, exchange service data for the third-party service with the metaverse system so that the metaverse system receives the third-party service.

15. The integration enabler of claim 14, wherein the instructions, when executed by the processor, cause the integration enabler to verify access rights to the third-party service by interacting with the metaverse system.

16. The integration enabler of claim 14, wherein the instructions, when executed by the processor, cause the integration enabler to:
transmit authentication credentials or tokens for verifying access rights of the user to the third-party service system; and
receive, from the third-party service system, an authentication result comprising access tokens and assertions for the third-party service according to the authentication credentials or the tokens.

17. The integration enabler of claim 16, wherein the authentication credentials and the tokens are changed into a format required by the third-party service system.

18. The integration enabler of claim 14, wherein the instructions, when executed by the processor, cause the integration enabler to receive authorization metadata comprising at least one of token expiration, scope, or user roles to inform access control determinations of the third-party service system.

19. The integration enabler of claim 14, wherein the instructions, when executed by the processor, cause the integration enabler to:
verify authentication requirements for the third-party services; and
change a format of a message comprising the authentication information based on the authentication requirements and transmit the changed message to the third-party service system.

20. The integration enabler of claim 14, wherein the instructions, when executed by the processor, cause the integration enabler to exchange the service data with the metaverse system by converting a communication protocol between the metaverse system and the third-party service system.
